(19) United States
(12) Patent Application Publication
(10) Pub. No.: US 2019/0114789 A1
(43) Pub. Date: Apr. 18, 2019

(54) METHOD OF OPERATING A VEHICLE TAIL LIGHT DETECTION SYSTEM FOR AN AUTOMATED CARWASH AND VEHICLE TAIL LIGHT DETECTION SYSTEM

(71) Applicant: SONNY'S ENTERPRISES, INC., Tamarac, FL (US)

(72) Inventors: PAUL FAZIO, PLANTATION, FL (US); ANTHONY ANALETTO, WESTON, FL (US)

(21) Appl. No.: 16/120,615

(22) Filed: Sep. 4, 2018

Related U.S. Application Data
(63) Continuation of application No. 62/571,462, filed on Oct. 12, 2017.

(51) Int. Cl. G06T 7/246; B60S 3/00; G06T 7/292

(52) U.S. Cl. CPC G06T 7/248; G06T 2207/30252; G06T 7/292; B60S 3/004

(57) ABSTRACT

In a carwash a vehicle is conveyed via a conveyor. An initial image of a rear portion of the vehicle traversing the carwash is captured. The initial image is processed and a recorded light intensity of a tail light of the vehicle is generated. A benchmark light intensity is derived from the light intensity and a margin of error. Sample images of the tail lights of the vehicle are periodically obtained. The sample images are processed to derive sampled tail light intensities. The sampled tail light intensities are compared to the benchmark tail light intensity. The conveyor is stopped if a sampled tail light intensity is greater than the benchmark tail light intensity.

### CROSS-REFERENCE TO RELATED APPLICATION

This application claims the priority, under 35 U.S.C. § 119, of provisional patent application Ser. No. 62/571,462, filed Oct. 12, 2017; the prior application is herewith incorporated by reference in its entirety.

### BACKGROUND OF THE INVENTION

### Field of the Invention

The invention relates to automated carwashes and the ability to detect a vehicle that is temporarily stopped within a carwash tunnel via a vehicle tail light detection system.

Automatic carwashes are designed to process as many vehicles as possible in a given period of time. One goal of these car washing systems is to maintain a constant flow of vehicles through the carwash. In order to achieve this goal, it is imperative to detect when a vehicle stops moving in a carwash tunnel of a carwash.

Driver error is the most common cause of pileups at conveyor-driven car washes. In this scenario, a driver accidentally or purposely hits the brakes or shifts out of neutral, which causes their vehicle to hop the roller. If the car stops moving and the conveyor is not stopped, vehicles collide into each other and create a pileup.

Self-driving technology also contributes to in-tunnel collisions. Some new cars are programmed to avoid accidents by applying the brakes when a threat is detected. During a car wash, this technology can be problematic because spinning brushes and other equipment may be mistaken as threats. In this scenario, the technology detects the threat, applies the brakes, and the vehicle hops the roller, which causes a pileup. Auto manufacturers are aware of this problem, and some publish instructions for carwash mode, but most drivers are unaware of the risk so they usually don't know to look for these instructions in the first place.

It is best to detect vehicle stoppages using existing components of the carwash or to add as few new components as possible and use existing components such as existing controllers, cameras and sensors. In this manner, an inexpensive stopped vehicle detector is possible and may be implemented as a retrofit kit or simply software.

### SUMMARY OF THE INVENTION

The invention is based on the object of a method of operating a vehicle tail light detection system for an automated carwash and a vehicle tail light detection system, which is technology non-complex and uses existing components of the carwash.

With the foregoing and other objects in view there is provided, in accordance with the invention, a method for operating an automated carwash having a carwash tunnel, a conveyor having rollers disposed in the carwash tunnel, a controller and at least one image sensor disposed in the carwash tunnel. Initially a vehicle is conveyed into the carwash tunnel. An initial image of a tail light of the vehicle is captured at an entry region of the carwash tunnel. A benchmark tail light intensity is generated from the initial image. A sample image is captured of the tail light of the vehicle disposed further along the carwash tunnel in a direction of travel. A sample tail light intensity is generated from the sample image. The sample tail light intensity is compared with the benchmark tail light intensity. The conveyor is stopped and thus the vehicle is stopped if the sample tail light intensity is greater than the benchmark tail light intensity.

In automated carwash tunnels rollers push the car through the tunnel while different pieces of equipment wash the vehicle as it passes by. At high volume locations, cars travel on carwash conveyors back-to-back with only a few feet between the vehicles. If a driver steps on a vehicle brake pedal while traversing through the carwash, it causes the wheel of the vehicle to jump off a roller of the transporting conveyor which pushes the vehicle via the wheel. The vehicle becomes stationary while waiting for a second roller to reach the tire position to continue to push the vehicle. If the trailing vehicle is only a few feet behind, this situation can potentially cause a collision inside the tunnel between the next approaching vehicle and the stationary vehicle. The invention solves this problem by using sensors disposed throughout the carwash tunnel to identify stopped vehicles.

Instead of using expensive radar based sensors for detecting stopped vehicles, inexpensive image or light sensors are used to detect intensities (e.g. changed intensities) of the tail lights on vehicles disposed inside the automated carwash tunnel. At this time we note that tail lights generate a higher intensity when the brake pedal is applied than when the brake pedal is not applied. The intensity data of the images get filtered in order to remove other lights including red lights used inside the carwash tunnel. Once it is detected that the brakes of a vehicle have been activated, the conveyor is signaled to stop. This system therefore prevents a potential collision, yet maintains the high through put of the carwash operation.

As the vehicle travels through the carwash, image sensors analyze the back of the vehicle and compare images to a benchmark image taken at the beginning of the process. Images are analyzed and filtered to remove background noise and isolate only the tail lights of the vehicle, which is then continuously compared to the benchmark readings.

In accordance with an added mode of the invention, the initial image and the sample image are captured by at least one image sensor. Alternatively or additionally, the initial image is captured by a first image sensor and the sample image is captured by a second image sensor.

In accordance with another mode of the invention, the method is continuously repeated wherein newly generated sample tail light intensities are compared with the benchmark tail light intensity.

In accordance with an additional mode of the invention, the initial image is filtered for removing background lighting.

In accordance with a further mode of the invention, the benchmark light intensity derived from the initial image is generated with a margin of error.

With the foregoing and other objects in view there is provided, in accordance with the invention, a method for operating an automated carwash having a carwash tunnel, a conveyor having rollers disposed in the carwash tunnel, a controller and at least one image sensor disposed in the carwash tunnel. In the method, a vehicle is conveyed into the carwash tunnel and an initial image of a tail light of the vehicle is captured at an entry region of the carwash tunnel. A benchmark tail light intensity is generated from the initial image. A sample image is captured of the tail light of the vehicle disposed further along the carwash tunnel in a direction of travel. A sample tail light intensity is determined from the sample image. The sample tail light intensity is compared with the benchmark tail light intensity and it is determined that a braked vehicle is present if the sample tail light intensity is greater than the benchmark tail light intensity. Next, it is determined if a further vehicle is approaching the braked vehicle, if no further vehicle is detected or a distance to the further vehicle is above a distance threshold, the operation of the conveyor is continued, otherwise the conveyor is stopped.

With the foregoing and other objects in view there is further provided, in accordance with the invention, an automated carwash. The automated carwash contains a carwash tunnel, a conveyor for conveying vehicles in the carwash tunnel, and at least one image sensor for imaging tail lights of the vehicles. The image sensor has a processing unit for processing image data including intensity levels of light output by the tail lights of the vehicle. The processing unit is programmed to:
a) allow a conveyance of a vehicle in the automated carwash via the conveyor;
b) capture an initial image of a rear portion of the vehicle traversing the automated carwash;
c) filter the initial image and record a light intensity of a tail light of the vehicle;
d) generate a benchmark tail light intensity derived from the light intensity;
e) periodically capture sample images of the tail lights of the vehicle;
f) process the sample images to derive sampled tail light intensities;
g) compare the sampled tail light intensities to the benchmark tail light intensity; and
h) stop the conveyor if a sampled tail light intensity is greater than the benchmark tail light intensity.

Other features which are considered as characteristic for the invention are set forth in the appended claims.

Although the invention is illustrated and described herein as embodied in a method of operating a vehicle tail light detection system for an automated carwash and a vehicle tail light detection system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a carwash tunnel with image sensors according to the invention; and

FIG. 2 is a flow chart for explaining a method of the invention.

### DETAILED DESCRIPTION OF THE INVENTION

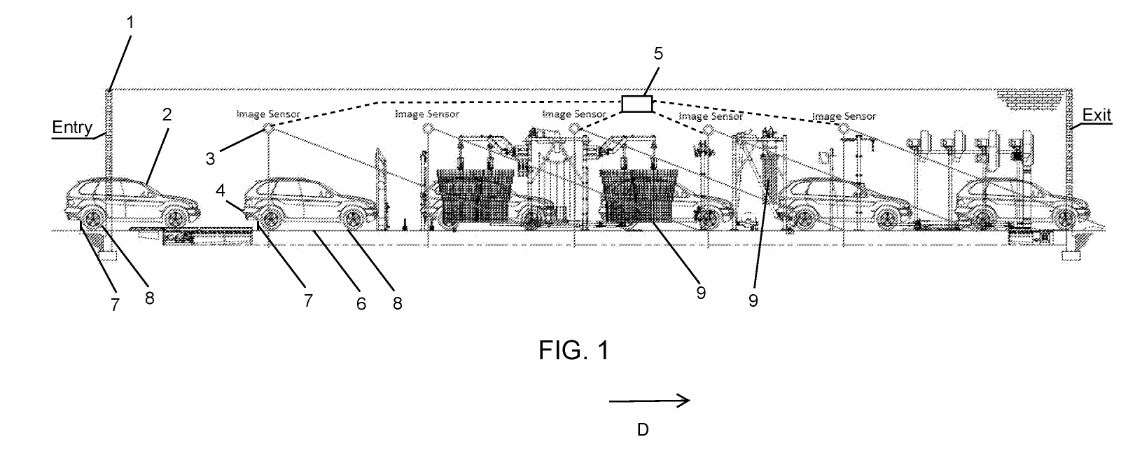

Referring now to the figures of the drawings in detail and first, particularly to FIG. 1 thereof, there is shown a vehicle carwash tunnel 1. The carwash tunnel 1 generally contains an entrance, an exit, and one or more pieces of wash equipment. Wash equipment may comprise, brushes, sprayers, dispensers, blowers, mitters, or the like, as would be understood by one of ordinary skill in the art.

Within the tunnel 1 are a plurality of vehicles 2 traversing the tunnel 1 and going from one carwash station to another along a direction of travel D. Throughout the carwash tunnel 1 is a plurality of image sensors 3 that constantly monitor a luminosity or light intensity output by vehicle tail lights 4. When a carwash customer presses his/her brake lights there is a change in the intensity of light output by the vehicle 2. The pressing of the brakes may also occur due to actuation of an automated safety system. The light intensity signals are provided to a processing unit 5 which analyzes the data. The processing unit 5 can be a standalone processor connected to all of the image sensors or can be incorporated in one or more image sensors 3. However, the processing unit 5 is usually an existing processor configured to control the equipment in the wash tunnel 1.

A conveyor 6 transports the vehicle 2 throughout the tunnel 1. A roller 7 of the conveyor 6 engages behind a wheel 8 of the vehicle 2 and pushes the vehicle 2 along. If the operator of the vehicle 2 presses down on the brake pedal, the vehicle 2 will hop over the roller 7 and stop until a following roller 7 engages the wheel 8 for further transport of the vehicle 2 in the carwash tunnel 1.

At this point we note that the image sensors 3 in the carwash tunnel 1 are generally used for positioning brushes 9 and other carwash equipment in relationship to incoming vehicles 2. More specifically, the brushes 9 are positioned and spaced in dependence on a sensed vehicle size, shape and velocity. At this point we emphasize that the image sensors 3 used in the tail light sensing are already disposed in the carwash tunnel 1 and do not have to be special or new image sensors 3.

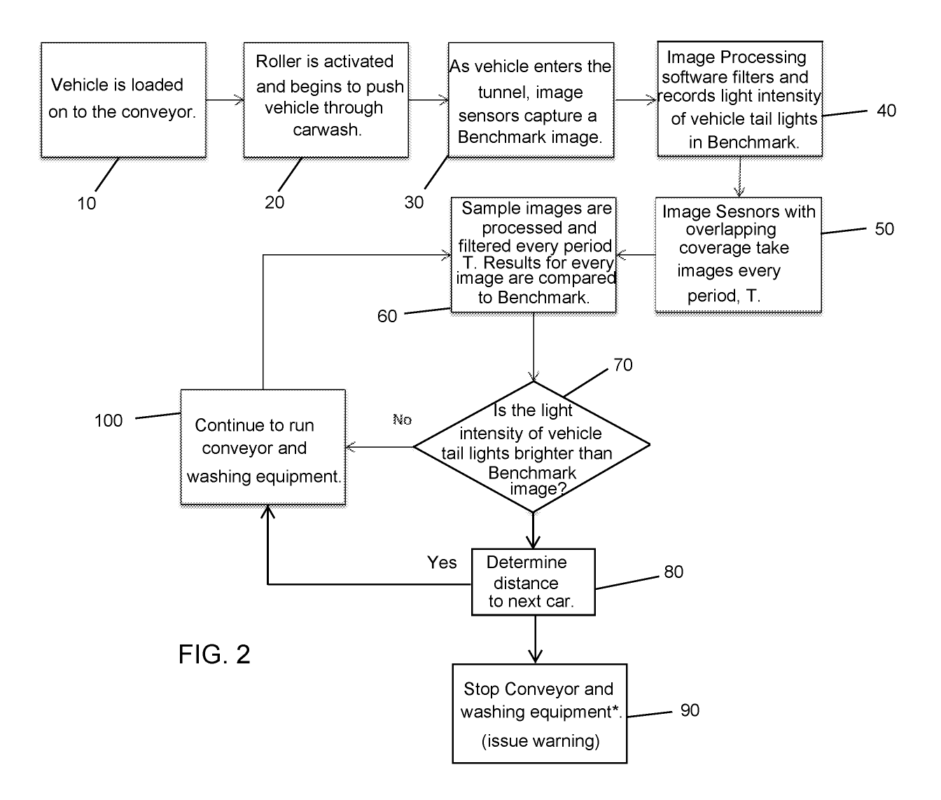

FIG. 2 is a flow chart diagramming the basic principles of the invention. In step 10 the vehicle 2 is loaded onto the conveyor 6. In step 20, the roller 7 is activated and pushes the vehicle 2. In step 30, the image sensors 3 capture an initial image. In step 40, image software filters the initial image in order to remove other lights including red lights used inside the carwash tunnel and records the light intensity of the tail lights 4 in the initial image and outputs a benchmark tail light intensity based on the initial image and an error margin. In step 50, at least one image sensor 3 and preferably a plurality of images sensors 3 periodically monitor the tail lights 4 of the vehicle 2 and continuously output new sample images. In step 60, the sample image is processed and filtered resulting in a sampled tail light intensity. In step 70, the sampled tail light intensity is compared to the benchmark tail light intensity. If the sampled tail light intensity is greater than the benchmark tail light intensity a braked vehicle is detected. Upon detection of the braked vehicle, a distance to a following vehicle is determined, step 80. If no vehicle or the distance to the following vehicle is great enough that another roller 7 will engage the wheel 8 of a braked car, the operation of the carwash is continued. If it is determined that the distance to following distance is short, the conveyor 6 is stopped and a warning signal is generated, step 90. For example, the warning signal may be an audible signal, a light based signal, and/or a text signal.

In step 70, if the sampled tail light intensity is less than the benchmark tail light intensity, the system continues with another sampling period, step 100.

1. A method for operating an automated carwash having a carwash tunnel, a conveyor having rollers disposed in the carwash tunnel, a controller and at least one image sensor disposed in the carwash tunnel, which comprises the steps of:
a) conveying a vehicle into the carwash tunnel;
b) capturing an initial image of a tail light of the vehicle at an entry region of the carwash tunnel;
c) generating a benchmark tail light intensity from the initial image;
d) capturing a sample image of the tail light of the vehicle disposed further along the carwash tunnel in a direction of travel;
e) generating a sample tail light intensity from the sample image;
f) comparing the sample tail light intensity with the benchmark tail light intensity;
g) stopping the conveyor and thus the vehicle if the sample tail light intensity is greater than the benchmark tail light intensity.

2. The method according to claim 1, which further comprises capturing the initial image and the sample image with the at least one image sensor.

3. The method according to claim 1, which further comprises capturing the initial image with a first image sensor and the sample image with a second image sensor.

4. The method according to claim 1, which further comprises continuously repeating steps d)-g).

5. The method according to claim 1, which further comprises filtering the initial image for removing background lighting.

6. The method according to claim 1, which further comprises continuously repeating steps d)-g) with sample images from a plurality of image sensors.

7. The method according to claim 1, which further comprises generating the benchmark light intensity derived from the initial image with a margin of error.

8. A method for operating a carwash, which comprises the steps of:
conveying a vehicle into the carwash via a conveyor;
capturing an initial image of a rear portion of the vehicle traversing the carwash;
filtering the initial image and recording a light intensity of a tail light of the vehicle;
generating a benchmark tail light intensity derived from the light intensity and a margin of error;
periodically capturing sample images of the tail lights of the vehicle based on a periodic time;
processing the sample images to derive sampled tail light intensities;
comparing the sampled tail light intensities to the benchmark tail light intensity; and
stopping the conveyor if a sampled tail light intensity is greater than the benchmark tail light intensity.

9. A method for operating an automated carwash having a carwash tunnel, a conveyor having rollers disposed in the carwash tunnel, a controller and at least one image sensor disposed in the carwash tunnel, which comprises the steps of:
conveying a vehicle into the carwash tunnel;
capturing an initial image of a tail light of the vehicle at an entry region of the carwash tunnel;
generating a benchmark tail light intensity from the initial image;
capturing a sample image of the tail light of the vehicle disposed further along the carwash tunnel in a direction of travel;
generating a sample tail light intensity from the sample image;
comparing the sample tail light intensity with the benchmark tail light intensity and determining that a braked vehicle is present if the sample tail light intensity is greater than the benchmark tail light intensity; and
determining if a further vehicle is approaching the braked vehicle, if no further vehicle is detected or a distance to the further vehicle is above a distance threshold, continue operating the conveyor, otherwise the conveyor is stopped.

10. An automated carwash, comprising:
a carwash tunnel;
a conveyor for conveying vehicles in said carwash tunnel; and
at least one image sensor for imaging tail lights of the vehicles, said image sensor having a processing unit for processing image data including intensity levels of light output by the tail lights of the vehicle, said processing unit programmed to:
allow a conveyance of a vehicle in the automated carwash via said conveyor;
capture an initial image of a rear portion of the vehicle traversing the automated carwash;
filter the initial image and record a light intensity of a tail light of the vehicle;
generate a benchmark tail light intensity derived from the light intensity;
periodically capture sample images of the tail lights of the vehicle;
process the sample images to derive sampled tail light intensities;
compare the sampled tail light intensities to the benchmark tail light intensity; and
stop the conveyor if a sampled tail light intensity is greater than the benchmark tail light intensity.
